(19) United States
(12) Patent Application Publication
(10) Pub. No.: US 2024/0002153 A1
(43) Pub. Date: Jan. 4, 2024

(54) ROBOTIC SYSTEM TO FULFILL ORDERS USING COOPERATING ROBOTS

(71) Applicant: Dexterity, Inc., Redwood City, CA (US)

(72) Inventors: Samir Menon, Atherton, CA (US); Wen Hsuan Hsieh, Los Altos, CA (US); Zhouwen Sun, Redwood City, CA (US)

(21) Appl. No.: 18/214,086

(22) Filed: Jun. 26, 2023

Related U.S. Application Data
(60) Provisional application No. 63/356,858, filed on Jun. 29, 2022.

(51) Int. Cl. B65G 1/137; B65G 1/04; G06Q 10/087

(52) U.S. Cl. CPC B65G 1/1375; B65G 1/0492; G06Q 10/087

(57) ABSTRACT

A robotic system comprising a plurality of autonomously acting robots configured to cooperate with each other to perform an operation is disclosed. In various embodiments, a system as disclosed herein includes a first robot configured to determine a plurality of items required to be obtained to fulfill a first order; and a second robot configured to receive an indication to retrieve and provide to the first robot a first item included in the plurality of items; and to plan and perform a first subtask to retrieve the first item and provide the first item to the first robot.

### CROSS REFERENCE TO OTHER APPLICATIONS

This application claims priority to U.S. Provisional Patent Application No. 63/356,858 entitled ROBOTIC SYSTEM TO FULFILL ORDERS USING COOPERATING ROBOTS filed Jun. 29, 2022, which is incorporated herein by reference for all purposes.

### BACKGROUND OF THE INVENTION

Robotic systems have been used to automate warehouse, shipping, and order fulfillment operations. Increasingly, robots work autonomously to perform tasks, such as to pick and place items in a box or other receptacle for shipment.

Typically, robots work independently, and a given robot typically is used to perform a discrete set of tasks comprising a portion of the workflow required to fulfill orders, for example. Human workers or robots working in isolation from one another are required to perform other, related tasks, such as unloading deliveries from suppliers, filling bins or chutes from which robots pick to fulfill orders, etc.

### BRIEF DESCRIPTION OF THE DRAWINGS

Various embodiments of the invention are disclosed in the following detailed description and the accompanying drawings.

FIG. 1 illustrates an embodiment of a robotic system to fulfill orders (or perform other integrated operations) using cooperating robots.

FIG. 2 illustrates an embodiment of a robotic system to fulfill orders (or perform other integrated operations) using cooperating robots.

FIG. 3 illustrates an embodiment of a planner subsystem of a robotic system to fulfill orders (or perform other integrated operations) using cooperating robots.

FIG. 4 illustrates an embodiment of a multi-level hierarchical set of planner subsystems comprising a robotic system to fulfill orders (or perform other integrated operations) using cooperating robots.

FIG. 5 is a flow diagram illustrating an embodiment of a process to fulfill orders using cooperating robots.

FIG. 6 is a flow diagram illustrating an embodiment of a process to identify and perform, autonomously, subtasks associated with order fulfillment using cooperating robots.

FIG. 7 is a flow diagram illustrating an embodiment of a process to fulfill orders using cooperating robots.

FIG. 8 is a flow diagram illustrating an embodiment of a process to optimize fulfillment of orders using cooperating robots.

FIG. 9 is a flow diagram illustrating an embodiment of a process to identify and perform, autonomously, subtasks associated with order fulfillment using cooperating robots.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

An autonomous, integrated robotic system is disclosed, in which multiple robots work cooperatively and, at least at times, in proximity, to perform seamlessly an integrated set of activities comprising an end-to-end workflow for order fulfillment or similar operations. In various embodiments, one robot or set of robots may unload trucks or other containers via which items have been delivered to a warehouse or other physical location. Mobile robots, robotically controlled conveyors, and/or other robotically controlled instrumentalities may be used in an integrated and at least partly coordinated manner to move items from the loading docks to shelves, bins, or other item-specific staging areas. Still another set of one or more robots may be tasked with pulling items from the shelves and bins and bringing them to collection points and/or handing them off actively to other robots, which then place the items in boxes or otherwise assembles sets of items for further delivery downstream, such as to fulfill an order.

In various embodiments, a robot station includes one, two, or more robots. The station is configured to use the robots and/or each robot is configured to fulfill orders, e.g., consumer or other orders for a set of one or more items, each in an indicated quantity, to be shipped to a destination (e.g., delivery address) associated with the order. In various embodiments, a robot station as disclosed herein may include one or more stationary robots, e.g., six degree of freedom robotic arms mounted to the floor, a stationary base, and/or another non-mobile structure. In some embodiments, one or both of the robot station robots may be rail-mounted and/or otherwise fully or partially mobile.

The following is an example of a fully autonomous order fulfillment workflow, in various embodiments:
Robot Station receives order to fulfill
Robot Station pings mobile robot and, in some embodiments, robotically controlled shelves, e.g., to extract the correct shelf/tote/bin/tray/product (source receptacle/item) from storage and present to mobile robot for retrieval
Mobile robot retrieves source receptacle/item and carries to robot station
Robot station arm 1 receives source receptacle/item from mobile robot and presents it to robot station arm 2
Robot station arm 2 picks from source receptacle or grasps item (if single item) and transfers to destination tote/box/bin/bag or other destination receptacle for fulfillment
Robot station arm 1 returns source receptacle, if any, via same or different mobile robot, which returns to shelf

In some embodiments, the above process can be reversed, e.g., to unpack items or receptacles at the robot station and deliver to shelves/storage locations using a mobile robot.

In various embodiments, each of a plurality of robots may act autonomously, but in cooperation with one or more other robots, to perform subtasks associated with completing a task or operation, such as fulfilling an order or achieving another operational objective. For example, an order to ship specified quantities of items A, B, and C, respectively, to a destination may be fulfilled by one or more robots configured to retrieve the required items from storage shelves or bins and place them in a staging area accessible to another robot that is configured to retrieve the items from the staging area, pack them into a box, and cause the box to sent to the destination, such as by affixing a label or routing the packed box to a downstream robot, station, and/or process to be labeled and shipped to the destination.

In some embodiments, the robots configured to retrieve the items from the storage shelves, bins, or other source locations may be configured to pull subtasks autonomously from one or more queues or other data structures. In some embodiments, the robots may be configured to each compute a cost associated with that robot completing a given subtask. A robot may be selected (or select itself) to perform a subtask if its cost is lower than a threshold and/or lower than any competing bid/cost computed or submitted (e.g., posted in a data structure) by another robot capable of performing the subtask.

In some cases, a robot fulfilling the order, e.g., one configured to pack items into a box or other container for shipment, may call one or more other robots to request retrieval of one or more items required to fulfill the order. For example, the robot may request that a specific robot perform a subtask, or may advertise, post, or otherwise make known to other robots the need to have the subtask performed.

In various embodiments, one or more techniques may be used to determine which robot will perform a given subtask, in situation in which more than one robot may be capable of performing the subtask. For example, a supervisory process may assign subtasks to robots; or the robots may bid based on cost or other metrics or factors, as in the example above; or the robots may negotiate or otherwise decide among themselves, according to a work allocation protocol, which of them will perform a given subtask; or subtasks may be pulled from a queue on a first (or last) in first out or other basis, by way of example and without limitation.

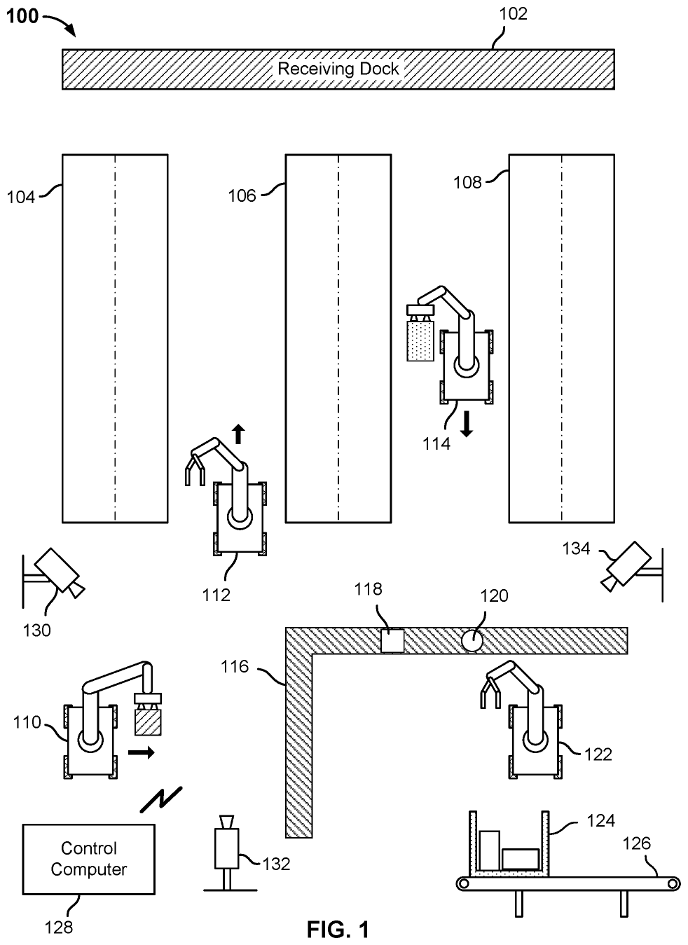

FIG. 1 illustrates an embodiment of a robotic system to fulfill orders (or perform other integrated operations) using cooperating robots. In the example shown, robotic system and workspace 100 includes a receiving dock 102 at which deliveries, e.g., via trucks or other transport and/or containers not shown in FIG. 1, are received. In some embodiments, a first set of robots and/or robotically controlled conveyors, forklifts, or other robotic instrumentalities, may be used to unload the trucks or other containers. Items and/or boxes, pallets, or other containers or sets of items, received at receiving dock 102 may be conveyed to corresponding, designated, and/or tracked locations on storage/staging shelves 104, 106, and 108, in this example, e.g., by mobile robots 110, 112, and 114 and/or by a second set of robots not shown in FIG. 1.

In various embodiments, one or more of the shelves 104, 106, and 108 may comprise a robotically controlled storage system configured to receive items or boxes or other containers of items, e.g., items received at receiving dock 102, and to use robotically controlled instrumentalities, such as conveyors, robotic arms, etc., to move items or containers of items into deeper and/or less accessible storage. When an indication is received that a given item or container of items is needed, e.g., to be retrieved by one or more of the mobile robots 104, 106, and 108, the shelf system uses its robotic instrumentalities to retrieve and present the item or container of items for retrieval.

Referring further to FIG. 1, in the example shown the system 100 further includes mobile robots 110, 112, and 114. In this example, each of the mobile robots 110, 112, and 114 comprises a single robotic arm mounted on a robotically controlled mobile base. In various embodiments, the mobile robots 110, 112, and 114 may be used, under robotic control, to retrieve items from receiving dock 102 and deliver them to appropriate locations of the shelves 104, 106, and 108, and to retrieve items from the shelves 104, 106, and 108 and deliver them to a robot station, such as the one shown in the bottom right-hand corner of FIG. 1.

In the example shown, the robot station includes a transfer zone or table 116 to which the mobile robots 110, 112, and 114 deliver items or containers of items retrieved from the shelves 104, 106, and 108, such as items 118 and 120 in the example shown. In this example, a single, mobile robot 122 retrieves items from locations on transfer zone or table 116 and packs them into boxes or other shipping containers, such as box 124 shown on output conveyor 126. In various embodiments, a system such as system 100 may include robotically controlled instrumentalities to assemble box 124 and place box 124 on the conveyor 126, to print an address label and affix the label on box 124, to operate conveyor 126 to move box 124 to a downstream destination, etc.

The above-described robotic operations, in various embodiments, are performed autonomously, under control of one or more control computers 128. In this example, control computer 128 is shown as a single computer in wireless communications with the shelves 104, 106, and 108, mobile robots 110, 112, and 114, and robot station robot 122. In some embodiments, the robotic control functions described herein as being performed by control computer 128 and/or another control computer may be performed at least in part in a distributed manner, e.g., by computers comprising and/or otherwise associated with one or more of the shelves 104, 106, and 108, mobile robots 110, 112, and 114, and robot station robot 122. In some embodiments, each of the shelves 104, 106, and 108, mobile robots 110, 112, and 114, and robot station robot 122 operates independently of the other, but in cooperation to perform tasks jointly and/or sequentially to achieve a higher-level objective, as disclosed herein, such as to fulfill one or more orders.

The system 100 further includes sensors, in this example comprising 3D cameras 130, 132, and 134. In various embodiments, 3D image data, comprising RGB (red, green, blue) or other color/pixel data and depth information, are received by control computer 128 via wired or wireless communications from the cameras 130, 132, and 134. In various embodiments, additional cameras and/or other sensors (bar or other optical code readers, RF tag readers, etc.) may be installed in locations around the workspace and/or may be mounted on one or more robots, such as mobile robots 110, 112, and 114 and/or robot 122. In various embodiments, camera and other sensor data is provided to a computer vision subsystem, which uses the sensor data to construct and maintain a three-dimensional view of the workspace and the items, robots, and other robotically controlled instrumentalities present and/or working in the workspace.

In some embodiments, humans may be present in the workspace. Sensors, such as cameras 130, 132, and 134, may be used to keep track of where humans are located, and control computer 128 may be configured to operate the robots and robotically-controlled instrumentalities in the workspace in a manner that protects the humans from injury, such as by operating robots 110, 112, 114, and 122 more slowly, or pausing or hard stopping operation, if a human is nearby.

In some embodiments, the system 100 may operate according to a workflow as described above. For example, robot 122 may receive an order to be fulfilled. For example, robot 122 may pull a next order from a queue of orders, or may be assigned an order, or may choose a next order determined to have at least threshold degree of fit with robot 122, for example. Robot 122 then communicates with one or more of the mobile robots 110, 112, and 114 to prompt them to retrieve from the shelves 104, 106, and 108 and deliver to the robot station, e.g., transfer zone or table 116, items needed to fulfill the order. As items are received, robot 122 packs them into a box or other container, such as box 124, until all the items required by the order have been received and packed. The robot 122 then sends/releases the packed box or other container for downstream processing, such as to close and seal the box, print and affix an address label, and/or route for shipment to or towards the ultimate destination.

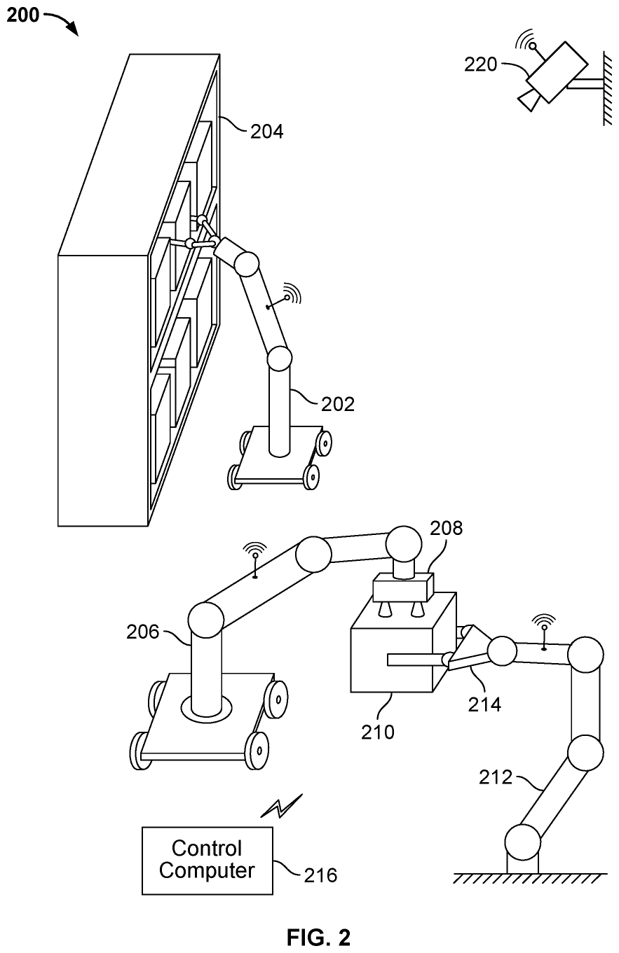

FIG. 2 illustrates an embodiment of a robotic system to fulfill orders (or perform other integrated operations) using cooperating robots. In the example shown, system and environment 200 includes a mobile robot 202 shown grasping an item from shelf 204, using a gripper type end effector. Mobile robot 206, equipped with a suction type end effector 208, has a box 210 in its grasp and is shown in the act of actively handing the box 210 off to a stationary robotic arm 212 equipped with a gripper type end effector 214, in this example. The mobile robot 202, mobile robot 206, and stationary robot 212 are in communication with control computer 216 via wireless communications. Control computer 216 receives sensor data from camera 220 and/or other sensors, via wireless communications in this example.

In operation, in various embodiments, the robots 202, 206, and 212 may cooperate to retrieve items from shelf 204 for delivery to a robot station with which robot 212 is associated, e.g., for order fulfillment as described herein. For example, robot 212 and/or a computer associated therewith may receive an order and task mobile robots 202, 206 with retrieving and providing to the robot 212 the items and/or containers of items needed to fulfill the order. For example, mobile robot 202 may have been assigned or have assigned to itself a task to review the box 210 from shelf 204, and to hand the box 210 over to mobile robot 206 for further delivery to robot 212, as shown in FIG. 2. Mobile robot 206 may have been assigned or may assigned to itself a task to receive the box 210 from mobile robot 202 and deliver and hand it over to robot 212, as shown in FIG. 2. In some embodiments, mobile robots 202 and 206 may implement a protocol to determine a mutually agreed location and manner to hand over an item, such as box 210. In some embodiments, the robots negotiate or otherwise determine according to the protocol a location and orientation in three-dimensional space to which mobile robot 202 was to present the box 210 to mobile robot 206 and, in some embodiments, a location of the mobile base of mobile robot 202 and/or a pose and location of its robotic arm. Similarly, the location and pose of robot 206 to receive the box 210 may be determined according to the protocol. Each robot 202, 206 maneuvers to the determined location and perform a handshake to transfer the box 210 from robot 202 to robot 206. For example, robot 202 may have indicated readiness to hand the box 210 over to robot 206 and robot 206 may have indicated readiness to receive the box 210. Next, robot 206 may have grasped the box 210, e.g., using suction type end effector 208 to grasp the box 210 from the top, as shown in FIG. 2, and informed robot 202 that robot 206 had the box 210 in its grasp. Robot 202 may then have indicated it was preparing to release its grip, and once acknowledged by robot 206 may have released its grip, withdrawn its end effector, and informed robot 206 that is had release the box 210 (or, robot 206 may have determined based on image, weight, force, or other sensor data that the box 210 had been released by robot 202). A similar coordination protocol and handshake may be performed by robot 206 and robot 212 to hand off the box 210 from robot 206 to robot 212, as in the state shown in FIG. 2.

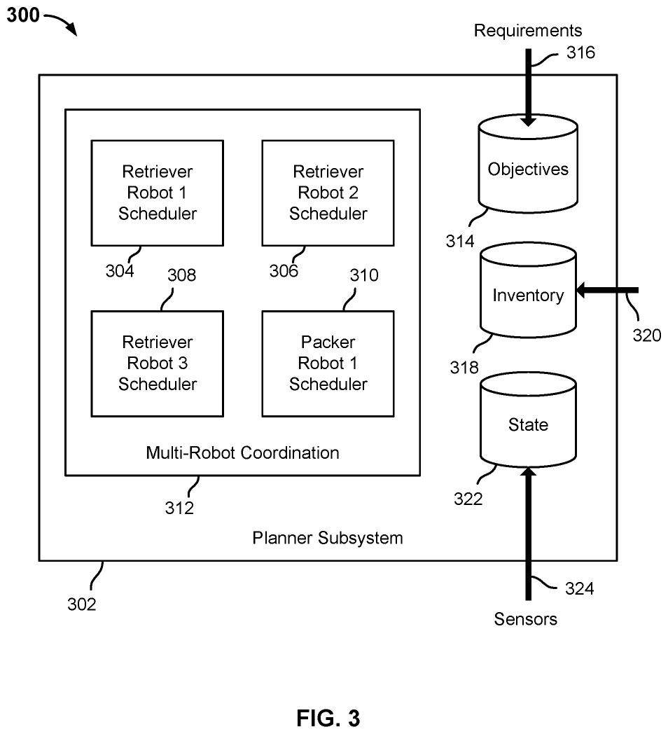

FIG. 3 illustrates an embodiment of a planner subsystem of a robotic system to fulfill orders (or perform other integrated operations) using cooperating robots. In the example shown, system 300 includes a planner subsystem 302 comprising a hierarchical planner that includes individual schedulers 304, 306, 308, and 310, each associated with a single corresponding robot, in this example, and a higher-level multi-robot coordination scheduler/planner 312 configured to coordinate efforts amongst the robots controlled by schedulers 304, 306, 308, and 310, e.g., to anticipate and take action to avoid physical collisions or other conflicts and/or to improve efficiency, such as by reassigning and/or reordering tasks to achieve a better global optimization according to some cost function.

In the example shown, sets of requirements (e.g., orders) 316 are received and stored in an objectives data store 314. Inventory data 320 is received and used to maintain an inventory database 318, e.g., comprising data representing the items available to fulfill orders (or other objectives) and where they are located. Sensor data 324 is received and used to estimate and update state information 322, e.g., to location of robots or other assets in the workspace; the location, position, and orientation of each item to be retrieved; etc.

In operation, in various embodiments, the packer robot scheduler 310 may retrieve an order or other objective from objectives data store 314 and may broadcast one or more tasks to retrieve and bring to the robot station items listed in the order. For example, the needed items may be added as retrieval tasks to the objective data store 314 and/or sent to each of the retriever robot schedulers 304, 306, and 308 and/or to a designated, selected, negotiated, and/or agreed one of them. The retriever robot schedulers 304, 306, and 308 may use the item retrieval task information and corresponding inventory data 318, 320 and sensor/state information 322, 324 to schedule and cause their corresponding robots to perform tasks to retrieve the required items and deliver them to the robot station with which the packer robot scheduler 310, which packs the items according to the order.

In the case of a conflict, race condition, risk of collision or detected inefficiency, the multi-robot coordination module 312 may intervene, in various embodiments, to re-sequence or otherwise adjust the timing of task performance as scheduled by one or more of the retriever robot schedulers 304, 306, and 308, for example, or to reassign retrieval tasks between and/or among them, e.g., to enable the set of tasks associated with the order to be accomplished more efficiently, to free a resource to be used to fulfill a different order, and/or to otherwise achieve greater optimization for the overall system.

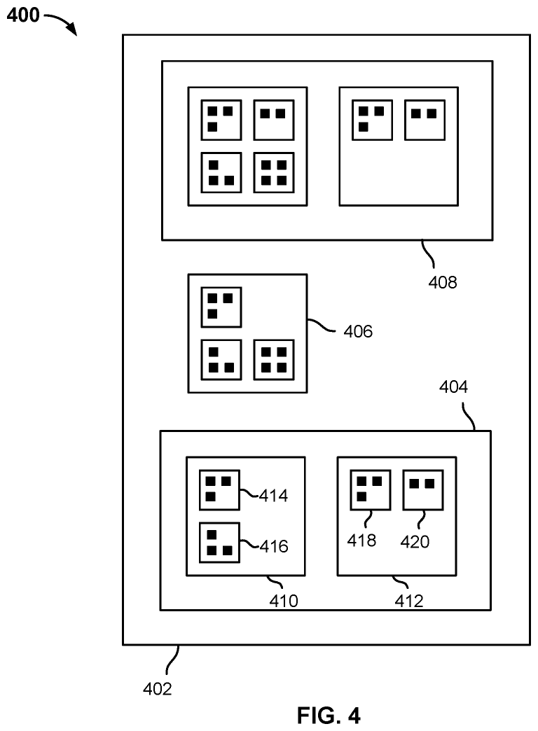

FIG. 4 illustrates an embodiment of a multi-level hierarchical set of planner subsystems comprising a robotic system to fulfill orders (or perform other integrated operations) using cooperating robots. In various embodiments, the use of robots to cooperatively perform tasks to achieve an objective, e.g., to fulfill a given order, as described above, may be extended further to achieve greater optimization even more globally. For example, cooperating robotic system across geographic locations may be used, in various embodiments, to achieve greater optimization. A first set of cooperating robots may be operated, using techniques disclosed herein, at a first location, to manufacture items “just in time” to be able to fulfill existing or anticipated orders. A second set of cooperating robots may be used to schedule empty trucks or other containers to become available to be loaded, by the second set of robots or other robots, just in time to be shipped to a downstream destination, such as a distribution center. The trucks (or other conveyances) themselves may be robots or robotically controlled and may be scheduled and operated as disclosed herein to transport items to their respective destinations at an opportune time to be unloaded from the trucks/containers and placed on shelves, as in the example shown in FIG. 1, and so on.

Referring to FIG. 4, a global (or other) hierarchical planner/scheduler 400 is shown to include a plurality of hierarchical planning subsystems, having the hierarchical relationships as illustrated in FIG. 4. For example, global hierarchical planning system 402 includes three hierarchical planning systems 404, 406, and 408 at a next level down in the hierarchy. Each of the hierarchical planning systems 404, 406, and 408 includes one or more further levels of hierarchy, as shown. For example, hierarchical planning system 404 is shown to include planning systems 410 and 412 in a next level lower in the hierarchy. Planning system 410 includes systems 414 and 416 in a next lower level of the hierarchy and planning system 412 includes systems 418 and 420 in the next level down, and so on.

In various embodiments, each lowest level planning system shown in FIG. 4 includes one or more robot (or other robotically controlled instrumentality) schedulers, such as robot schedulers 304, 306, 308, and 310 of FIG. 3, each configured to autonomously and independently schedule a corresponding robot to perform tasks, subject to being overruled and/or redirected by a higher level planner/scheduler configured to coordinate work among a plurality of robots.

In some embodiments, two or more robotic arms may be disposed on a single base or chassis, such as a mobile chassis. Each arm may be controlled independently of the other arm(s) or, in some embodiments, the arms may be operated in coordination under the control of a single robotic application and/or control module. The arms may be used to perform tasks cooperatively, such as by passing an item from one arm to another. For example, a first arm may be used to pick an item (e.g., from the floor, a shelf, or a bin) and may then hand the item to another hand, e.g., to carry and/or further secure the item while the chassis moves to a new location or to place the item at a location the first arm cannot reach.

In some embodiments, to perform a subtask as part of an operation being performed in cooperation with one or more robots, a participating robot may be required to configure or reconfigure itself to perform the subtask. For example, the robot may need to install a required end effector and/or grasp or otherwise obtain a tool.

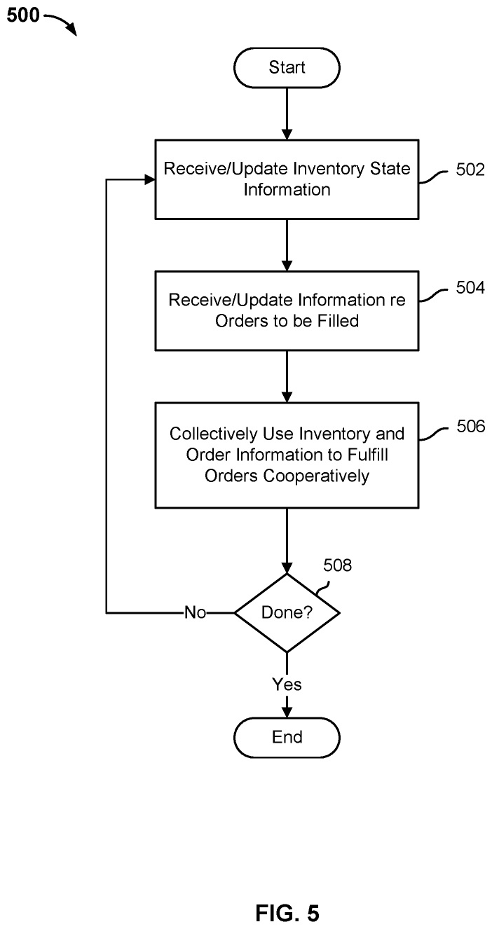

FIG. 5 is a flow diagram illustrating an embodiment of a process to fulfill orders using cooperating robots. In various embodiments, the process 500 of FIG. 5 may be implemented by a control computer, such as control computer 128 of FIG. 1. In the example shown, at 502, inventory and/or other state information is received and/or updated. For example, inventory information reflecting which items are available, in which quantities, at which locations, such as in a warehouse, order fulfillment center shelves/bins, or other source of items, may be received. At 504, information regarding orders to be fulfilled, such as invoice, order, or other similar information, is received. At 506, a plurality of robots collectively use the inventory and/or order information to fulfill orders, or perform other operations, cooperatively. Subsequent iterations of one or more of steps 502, 504, and 506 are performed unless/until it is determined at 508 that all orders have been processed (e.g., fulfilled), in which case the process end.

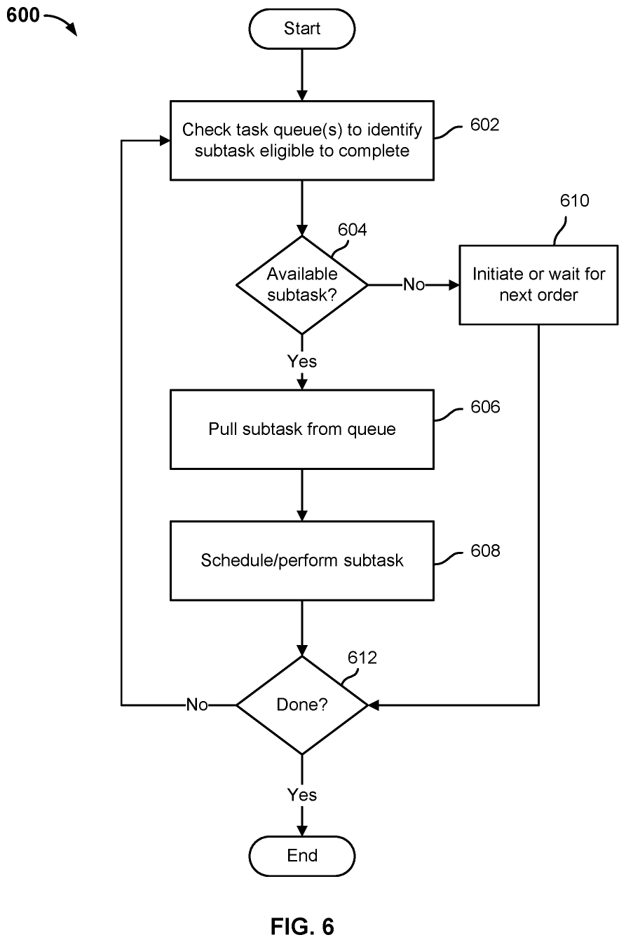

FIG. 6 is a flow diagram illustrating an embodiment of a process to identify and perform, autonomously, subtasks associated with order fulfillment using cooperating robots. In various embodiments, the process 600 of FIG. 6 may be implemented by a control computer, such as control computer 128 of FIG. 1, and/or control modules and/or processes comprising and/or otherwise associated with an individual, autonomous robot, such as robots 110, 112, and 114 of FIG. 1. In the example shown, at 602, a task queue is checked to identify a subtask a given robot is eligible to complete. For example, the robot itself (i.e., software, such as a robotics application, controlling or configured to control or direct the robot) may check the queue for a subtask the robot can perform. Examples of a subtask, in the context of an order fulfillment operation, include, without limitation, one or more of a retrieving an item or container of items from a source location and placing the item or container in a destination location, such as a location from which a second or other robot is able to retrieve the item (or an item from the container); restocking a shelf, container, or other receptacle with a set of one or more items that may and/or are known to be needed to fulfill one or more orders; and returning a container or other receptacle of items to an associated location, such as a source location from which the robot or some other robot previously retrieved the container or other receptacle, e.g., to enable another robot to access items from the container or other receptacle. At 604, if an available subtask is identified, the subtask is “pulled” from the queue, at 606, such as by marking the subtask as being “in progress” by or “assigned to” the robot. At 608, the robot makes and implements a schedule and plan to perform the subtask.

If no subtask suitable for completion by the robot is available (602, 604), at 610 the robot (and/or process or module performing process 600) either waits for a suitable subtask to be come available or, in some embodiments, initiates processing of one or more next orders. For example, a next order may be received or read from a data structure, and component subtasks added to the queue.

Once an assigned subtask is done (606, 608) or a new order is initiated (610), the process determines at 612 whether processing is completed (e.g., all orders have been fulfilled or work is paused or otherwise halted). If so, the process ends. If not, the process returns to step 602 and another iteration of steps 602, 604, 606, 608, 610, and/or 612, as applicable is performed.

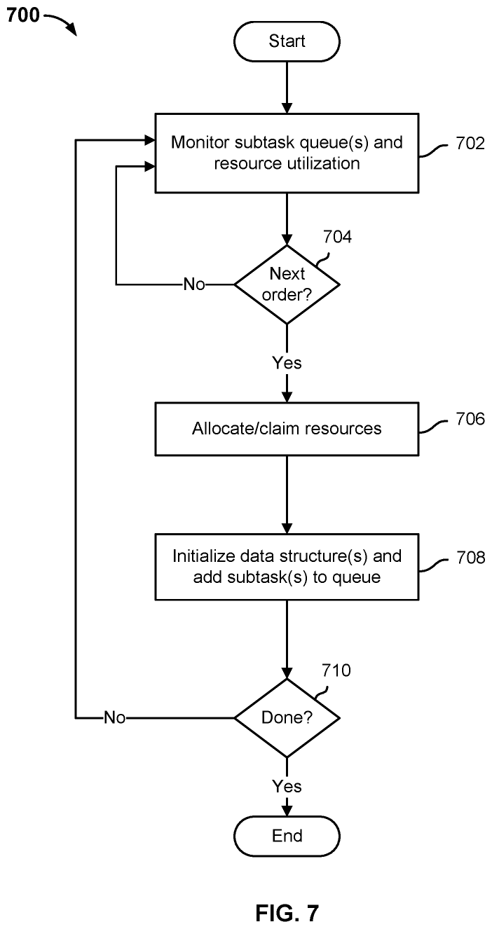

FIG. 7 is a flow diagram illustrating an embodiment of a process to fulfill orders using cooperating robots. In various embodiments, the process 700 of FIG. 7 may be implemented by a control computer, such as control computer 128 of FIG. 1. In the example shown, at 702, a subtask queue and associated resource utilization are monitored. For example, the number and/or nature of subtasks in the queue may be compared to the set of resources deployed/available to perform subtasks in the queue. If, at 704, the queue is determined to have too few subtasks queued up, e.g., compared to the number of robots available to perform subtasks in the queue, then subtasks associated with fulfilling one or more next orders are added to the queue, in this example by allocating resources at 706 (e.g., boxes/containers, shipping labels, items in inventory to fulfill the orders, etc.) and initializing and/or updating data structures at 708, such as by adding associated subtasks to the queue. Subsequent iterations of one or more of steps 702, 704, 706, and 708 may be performed unless/until it is determined at 710 that all orders have been fulfilled, in which case the process 700 ends.

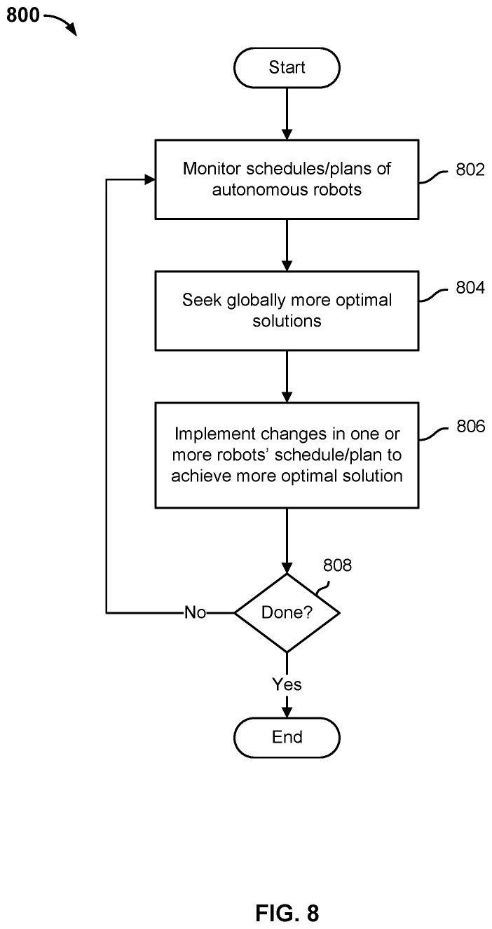

FIG. 8 is a flow diagram illustrating an embodiment of a process to optimize fulfillment of orders using cooperating robots. In various embodiments, the process 800 of FIG. 8 may be implemented by a control computer, such as control computer 128 of FIG. 1. In the example shown, at 802, the respective schedule(s) and/or plan(s) of a plurality of robots is/are monitored. For example, the subtasks each robot has been assigned and/or has assigned to itself may be monitored. At 804, on an ongoing, periodic, and/or continuous basis, a globally more optimal solution is sought. For example, the computer/module implementing the process 800 may apply one or more heuristics, rules, algorithms, and/or other techniques to determine if an allocation of subtasks other than the current allocation would result in better performance and/or lower cost. For example, if robot 1 were assigned to retrieve item A from location LA and item B from location LB, the subtask to retrieve item B may be reassigned to a robot 2 that is nearer to location LB, e.g., if such reassignment would not impose other costs, such as delaying robot 2 from performing another subtask. In some embodiments, a more optimal solution may be achieved by reordering the order in which subtasks already assigned to a robot are performed by that robot, or by reordering or otherwise reprioritizing subtasks still in the queue. At 806, changes to realize a more optimal solution are implemented. For example, in the example above robot 1 may be informed not to perform the subtask to retrieve item B and robot 2 may be informed to perform the subtask to retrieve item B.

In various embodiments, machine learning; artificial intelligence, including generative artificial intelligence; and/or other techniques may be used to determine and implement a globally more optimal solution.

Optimization processing (800) continues until done, e.g., all orders have been fulfilled (808).

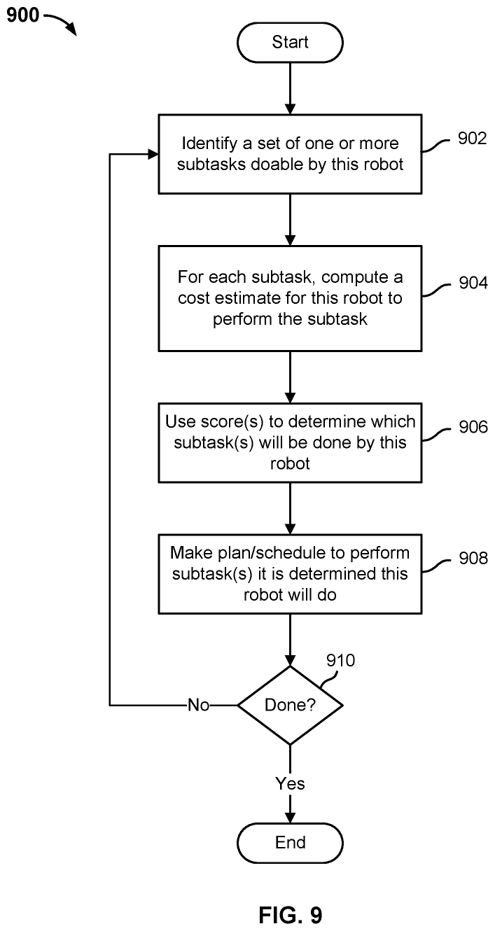

FIG. 9 is a flow diagram illustrating an embodiment of a process to identify and perform, autonomously, subtasks associated with order fulfillment using cooperating robots. In various embodiments, the process 600 of FIG. 6 may be implemented by a control computer, such as control computer 128 of FIG. 1, and/or control modules and/or processes comprising and/or otherwise associated with an individual, autonomous robot, such as robots 110, 112, and 114 of FIG. 1. In the example shown, at 902, a set of one or more subtasks capable of being performed by the robot with respect to which the process 900 is being performed are identified. For example, a robot and/or a robotic application configured to control the robot may identify subtasks that robot is capable of performing. At 904, for each subtask, a cost estimate is computed for the robot to perform that subtask. For example, the time, distance(s), energy consumption, charge level, or other state may be considered in computing a cost. The cost may reflect the incremental cost associated with adding the subtask to an existing set of subtasks already assigned to the robot. At 906, the score(s) is/are used to determine which subtasks will be performed by the robot. For example, the costs computed by or for robot 1 may be compared to the corresponding costs computed by or for one or more other robots, if any, and the robot with the lowest cost to perform the subtask may be assigned to perform the subtask. At 908, the robot makes/updates a schedule and plan to perform the subtask(s) that have been assigned to it, based at least in part on the cost(s) computed at 904. Process 900 continues, with further iterations of 902, 904, 906, and 908 being performed, until it is determined at 910 that the process 900 is done, e.g., all orders have been fulfilled and/or operations have ended temporarily and/or for the day.

In various embodiments, techniques disclosed herein are used to enable robots to work cooperatively to achieve objectives, such as to fulfill orders. Each robot operates autonomously but in cooperation with one or more other robots, as disclosed herein. While certain examples described in detail herein involve order fulfillment, in various embodiments other objectives may be achieved by a plurality of robots operating in cooperation as disclosed herein. For example, and without limitation, a first robot performing a repair, maintenance, or manufacturing activity may invoke or otherwise obtain the cooperation of another robot to perform an associated subtask, such as to retrieve a required part or other factor of production. In another example, a first robot may hold a part or assembly in position and obtain assistance from another robot to bolt or otherwise secure the part or assembly in place. In a further example, in the logistics/fulfillment context a first robot assigned to retrieve an item from a container or other source location may find the item is not at the location and may obtain cooperation by another robot to restock the item at the source location. In another example, a robot unloading a truck may place items on a conveyor belt or other conveyance structure and other robots may cooperate by performing subtasks to retrieve items from the conveyance structure and place them on a pallet, on a corresponding shelf, in an associated container, etc.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A robotic system, comprising:
a first robot configured to determine a plurality of items required to be obtained to fulfill a first order; and
a second robot configured to receive an indication to retrieve and provide to the first robot a first item included in the plurality of items; and to plan and perform a first subtask to retrieve the first item and provide the first item to the first robot.

2. The system of claim 1, wherein the second robot provides the first item to the first robot by placing the first item in a location from which the first robot is configured to retrieve the first item.

3. The system of claim 2, wherein the second robot places the item in the location and releases the first item and the first robot subsequently retrieves the first item from the location.

4. The system of claim 1, wherein the second robot provides the first item to the first robot by handing the first item off to the first robot.

5. The system of claim 4, wherein the second robot hands the first item off to the first robot at least in part by moving the first item to a position and orientation in which the first robot is able to grasp the first item while the first item remains in the grasp of the second robot.

6. The system of claim 4, wherein the second robot hands the first item off to the first robot at least in part by moving a receptacle comprising the first item to a position and orientation in which the first robot is able to grasp the first item and remove the first item from the receptacle.

7. The system of claim 1, wherein first robot is configured to request that the second robot retrieve and provide the first item to the first robot.

8. The system of claim 1, wherein second robot receives the indication to retrieve and provide the first item to the first robot at least in part by determining autonomously to retrieve and provide the first item to the first robot.

9. The system of claim 8, wherein the second robot determines autonomously to retrieve and provide the first item to the first robot at least in part by reading a data structure associated with fulfillment of the first order.

10. The system of claim 8, wherein the second robot determines autonomously to retrieve and provide the first item to the first robot at least in part by computing a cost associated with the second robot retrieving and providing the first item to the first robot.

11. The system of claim 1, wherein the first robot is further configured to fulfill the first order at least in part by placing the items comprising the plurality of items in a receptacle associated with the first order.

12. The system of claim 11, wherein the receptacle comprises a box or other container to be shipped to a destination associated with the first order.

13. The system of claim 1, wherein the first robot comprises a stationary robotic arm and the second robot comprises a mobile robot.

14. The system of claim 1, further comprising a processor configured to determine that a third robot is preferred to retrieve and provide the first item to the first robot; and to reassign from the second robot to the third robot the task to retrieve and provide the first item to the first robot.

15. The system of claim 1, further comprising a third robot configured to retrieve the first item from a receiving location at which a delivery comprising the first item was received and place the first item in a source location from which the second robot is configured to retrieve the first item.

16. The system of claim 15, wherein the third robot is configured to retrieve the first item from a box, container, or other receptacle in which the first item was delivered to the receiving location.

17. The system of claim 1, wherein the second robot retrieves the first item at least in part by retrieving and providing to a location associated with the first robot a container that includes a plurality of items, including the first item, and the first robot is configured to retrieve the first item from the container.

18. The system of claim 17, wherein the second robot is configured to return the container to a source location associated with the container in response to an indication that the first robot has retrieved the first item from the container.

19. A method, comprising:
determining, by a first robot, a plurality of items required to be obtained to fulfill a first order;
receiving, by a second robot, an indication to retrieve and provide to the first robot a first item included in the plurality of items;
wherein the second robot is configured to plan and perform, in response to receiving the indication, a first subtask to retrieve the first item and provide the first item to the first robot.

20. A computer program product embodied in a non-transitory computer readable medium and comprising computer instructions for:
determining, by a first robot, a plurality of items required to be obtained to fulfill a first order;
receiving, by a second robot, an indication to retrieve and provide to the first robot a first item included in the plurality of items;
wherein the second robot is configured to plan and perform, in response to receiving the indication, a first subtask to retrieve the first item and provide the first item to the first robot.
